(19) United States
(12) Patent Application Publication
(10) Pub. No.: US 2009/0308360 A1
(43) Pub. Date: Dec. 17, 2009

(54) Device for Magnetic Treatment and Purification of Fuel

(76) Inventors: Dumitru Istrati, Chisinau (MD); Natalia Istrati, Chisinau (MD)

Correspondence Address: AVERILL & VARN, 8244 PAINTER AVE., WHITTIER, CA, 90602, US

(21) Appl. No.: 12/477,784

(22) Filed: Jun. 3, 2009

(30) Foreign Application Priority Data
Jun. 11, 2008 (MD) 248

(51) Int. Cl. F02M 27/04

(52) U.S. Cl. 123/538

(57) ABSTRACT

A magnetic treatment and purification of fuel device contains a cylindrical body with an inlet pipe, and outlet pipe, and a magnetic system for treating fuel. The magnetic system comprises consecutive opposing pairs of C-shaped outer permanent magnets, installed in pairs along the body axis of the device and turned 90° with respect to a preceding pair of magnets and oriented with same poles facing each other, and additional spaced apart permanent cylindrical inner magnets residing coaxial and inside the C-shaped outer permanent magnets with same poles facing each other. The fuel flows through an annular path between the inner and out magnets and is thereby treated to improve combustion efficiency and reduce pollution.

The present application claims the priority under the Paris Convention for the Protection of Intellectual Property of Application Number of The Republic of Moldovian Patent Application Serial No. 248 filed Jun. 11, 2008, which application is incorporated in its entirety herein by reference.

### BACKGROUND OF THE INVENTION

The present invention relates to gasoline and diesel fuel treatment and in particular to the use of magnets to treat gasoline and diesel fuel to improve combustion.

It is a physical phenomenon, whereby the magnetic field changes the structure of the fluid environments, such as petroleum products, namely, atoms activate, molecular connections weaken with simultaneous polarization of the molecules that determines the changes in the physicochemical properties of the environment. As a result, the viscosity of the environment and the surface tension decrease, the speed of reaction with oxygen increases.

In relation to fuel for internal-combustion engines the change of characteristics under the influence of the magnetic field increases the effectiveness of its treatment, intensifies the processes of ignition and complete combustion, which in its turn improves the economic performance of the engine and its environmental performance by reducing emissions into ambient environment of hazardous substances from exhaust gases. There are known a number of devices, which are based on usage of this phenomenon. One of them is the fuel magnetic treatment device, as described in useful model RM Ns 157. A version of this device, depicted in FIG. 2, of the '157 patent is a module containing a fuel line, on which an electromagnet is placed. The electromagnet is placed in a ferromagnetic housing, covering the fuel line, and includes two coils, symmetrically mounted on the fuel line and contain cores of ferromagnetic rods.

The fuel line is made of nonferromagnetic material and has input and output sites in the course of fuel flow. Ferromagnetic rods are installed in the middle of the fuel lines, boosting the filtering properties of the devices and the voltage of the magnetic field in it.

The device of the '157 patent is very effective at fuel treatment, but in order to create a high concentration of electromagnetic energy in the right place of the module the directions of the magnetic fields in the electromagnet coil must match. Consequently, the coils must be installed strictly symmetrically on the fuel line, and the connection of windings should meet the established requirements. Thus, the use of this device involves some difficulty both in mounting and fitting it, also in ensuring the necessary working conditions, requiring the availability of power source.

Another device is the car fuel magnetic purification and treatment filter EKOMAG-10G, as described in the patent of Russia number 2268388. The patented device of the '388 patent is a cylindrical body with an input pipe, the cover with the discharging nozzle, magnetic system consisting of the C-shaped permanent magnets, installed in pairs along the body axis of the device with turning of each next pair at 90° and oriented in pair by same poles to each other, a cylindrical rod connected to the internal end of the cover and located inside the magnetic system coaxial with the formation of an annular channel between the outer surface of the rod and the inner surfaces of the magnets, whereby the cylindrical rod is made with an inner channel, in which additional permanent magnets are installed by the same poles close to each other or at distance from each other, and the free end of the rod is located opposite to the inlet fitting. At the same time the channel of the cylindrical rod is blind, and the ring channel is connected to the discharging nozzle through the radial channels, made in the rod near the internal end caps and outgoing to the blind channel.

During operation, the flow of fuel supplied by the input channel pipe at the end of the rod turns by 90 degrees to the annular channel, and further moves to the zone of magnetic field treatment. In internal end of the cover, at the end of annular channel, the fuel goes through the distribution radial channels to the channel of the discharge nozzle, twice changing the direction of its flow by 90 degrees, due to the design of this device

As a result, the fuel flow rate significantly decreases, its laminarity is altered by means of the emergence of boundary turbulent processes, and in the field of connection of the body cover, stagnation occurs. All this leads to a reduction in the effectiveness of fuel preparation.

In addition, the blind implementation of the internal channel of the rod makes the installation of additional permanent magnets difficult, introduction of which is through the discharge nozzle almost blindly. As a consequence, the process of filter assembling becomes complex, requiring compliance with certain size ratio's between filter elements, creating the magnetic field.

The challenge, which aims to solve the patented useful model is to create a device ensuring the high efficiency of fuel purification and treatment and easy to manufacture and service.

### BRIEF SUMMARY OF THE INVENTION

The present invention addresses the above and other needs by providing a device for magnetic treatment and purification of fuel. The device includes a two part cylindrical body with an outer body portion having an inlet pipe and an inner body portion with an outlet pipe, and a system of magnets. The magnetic system including C-shaped permanent outer magnets and cylindrical inner permanent magnets. The C-shaped outer magnets are installed in pairs along the body axis of the device with each pair rotated 90° with respect to the prior pair, and oriented with like poles facing each other. The cylindrical inner magnets reside in a cylindrical tube which is part of the inner body portion of the cylindrical body and reside coaxially inside the C-shaped outer magnets. The cylindrical tube and outer magnets form an annular channel between the outer surface of the tube and the inner surfaces of the C-shaped magnets for fuel passage. The cylindrical inner magnets are spaced apart and installed by the same poles facing each other. The free end of the cylindrical tube is located proximal to the inlet pipe and includes a removable cover allowing insertion go the cylindrical inner magnets. A path is created between the outer body portion of the cylindrical body and the cap to provide at least two channels, located at an angle to the longitudinal axis of the device and connecting the inlet pipe to the annular channel through the device. The inclination angle of the angled channels is in the range of 35 to 55 degrees to the longitudinal axis of the device.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a side view of a magnetic fuel treatment device according to the present invention.

FIG. 1B is an end view of the magnetic fuel treatment device according to the present invention.

FIG. 2 is a cross-sectional view of the magnetic fuel treatment device according to the present invention taken along line 2-2 of FIG. 1A.

FIG. 3 is a cross-sectional view of the magnetic fuel treatment device according to the present invention taken along line 3-3 of FIG. 2.

FIG. 4 is a cross-sectional view of the magnetic fuel treatment device according to the present invention taken along line 2-2 of FIG. 1A of an outer body portion of the body of the magnetic fuel treatment device according to the present invention.

FIG. 5 is a cross-sectional view of the magnetic fuel treatment device according to the present invention taken along line 2-2 of FIG. 1A of an inner body portion of the body of the magnetic fuel treatment device according to the present invention.

FIG. 6A is a front view of a pair of magnets in a first orientation of the magnetic fuel treatment device according to the present invention.

FIG. 6B is a side view of a pair of magnets in the first orientation of the magnetic fuel treatment device according to the present invention.

FIG. 7A is a front view of a pair of magnets in a second orientation of the magnetic fuel treatment device according to the present invention.

FIG. 7B is a side view of a pair of magnets in the second orientation of the magnetic fuel treatment device according to the present invention

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

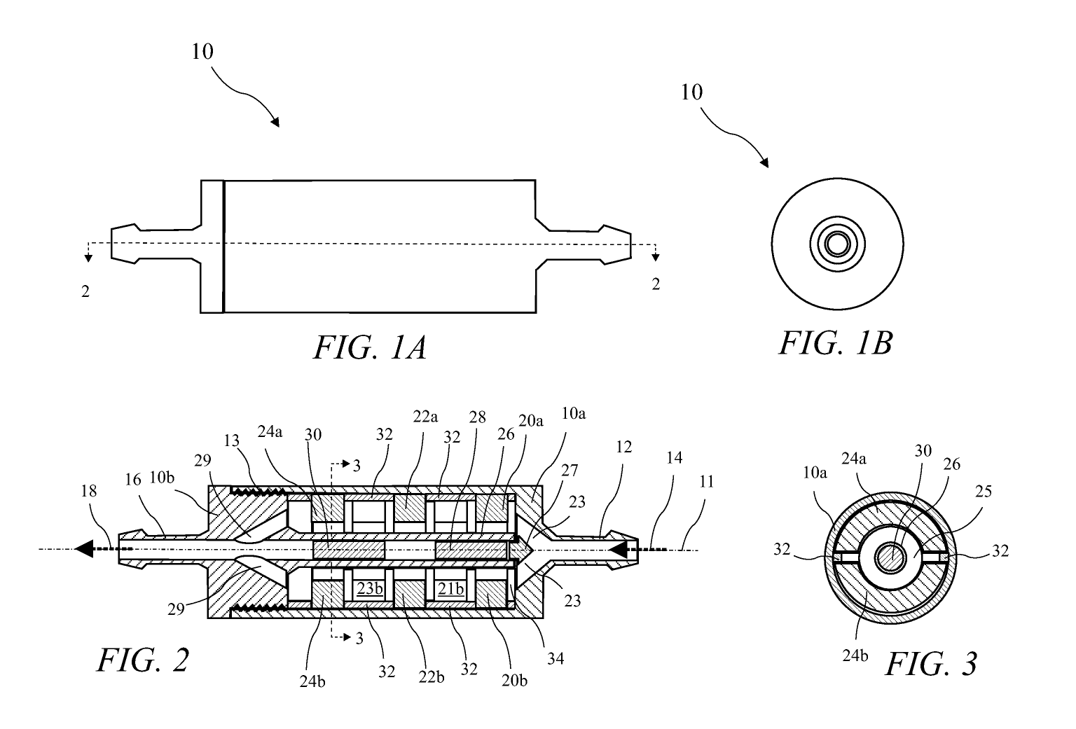

A side view of a magnetic fuel purification and treatment device 10 according to the present invention is shown in FIG. 1A and an end view of a magnetic fuel purification and treatment device 10 is shown in FIG. 1B. A cross-sectional view of the magnetic fuel treatment device 10 taken along line 2-2 of FIG. 1A is shown in FIG. 2 and a cross-sectional view of the magnetic fuel treatment device 10 taken along line 3-3 of FIG. 2 is shown in FIG. 3. The magnetic fuel purification and treatment device 10 includes a cylindrical body with an outer body portion 10a having an inlet pipe 12 receiving an in-flow of fuel 14 and an inner body portion 10b having an outlet pipe 16 providing an out-flow of fuel 18. A magnetic system comprising C-shaped permanent magnets 20a, 29b, 21a (not shown) and 21b, 22a, 22b, 23a (not shown) and 23b, and 24a and 24b, installed in pairs along the body axis of the device 10 with each consecutive pair turned at 90 degrees and each pair oriented with like poles (i.e., North N and South S) facing each other. The parallel row of permanent C-shaped magnets 20a, 20b, 21a, 21b, 22a, 22b, 23a, 23b, 24a, and 24b are installed in holder-separators 32.

A cylindrical tube portion 26 extends from inner body portion 10b of the body and resides inside the magnetic system coaxial with the C-shaped magnets forming an annular channel 25 between the outer surface of the cylindrical tube portion 26 and inner surfaces of the C-shaped magnets. The cylindrical tube portion 26 is made with an inner channel 38 (see FIG. 5), in which additional permanent magnets 28 and 30 are installed, spaced apart with like poles facing each other. The magnetic field created by the C-shaped magnets 20a, 20b, 21a, 21b, 22a, 22b, 23a, 23b, 24a, and 24b interacts with magnetic lines of force of magnets 28 and 39, forming a permanent magnetic field of a complex form and with necessary tension to treat and purify fuel flowing therethrough.

A free end 26a of the cylindrical tube portion 26 resides facing the inlet pipe 12 of the outer body portion 10a of the cover of the device 10 and a cap 27 resides over the free end 26a of the cylindrical tube portion 26. The flow 14 enters the annular channel 25 through at least two inlet channels 23, located at an angle to the longitudinal axis 11 of the device 10 and connecting the annular channel 25 to the inlet pipe 12. Further, the inclination angle of the inlet channels 23 is in the range of 35 to 55 degrees to the longitudinal axis 11 of the device. In addition, the removable cover 27 of the cylindrical tube portion 26 is preferably cone shape.

Outlet channels 29 connect the annular channel 25 with the outlet pipe 16. The outlet channels 29 reside in the inner body portion 10b of the cover of the device 10 and at an angle to its longitudinal axis 11 providing a laminar flow of fuel, further excluding the formation of stagnation in the places of fuel transition from the annular channel 25 to the outlet pipe 16, and consequently, improving the efficiency of purification and treatment.

To accommodate a preferred short size of the device 10, the outlet channels 29 are preferably implemented at an angle of 35-55 degrees to the longitudinal axis 11 of the device 10. Implementation of outlet channels 29 at angles beyond the preferred range may reduce the mechanical strength of the device by thinning material under the outlet channels 29. Moreover, for angles less than 35 degrees of plots in connection of channels with discharging nozzle, and for angles more than 55 degrees—in place of connection of channels with inlet fitting. (I don't understand the last sentence)

The provision of the passage 38 in the cylindrical tube 26 simplifies the introduction and installation of the permanent magnets 28 and 30 into the cylindrical tube 26, through the free end 26a, with the cover 27 removed, as opposed to known technical solutions. Moreover, the proposed design facilitates, for example, a preventive cleaning of the device 10 whereas a more complex configuration of the fuel flow path and the presence of a blind cylindrical tube makes cleaning difficult in known devices.

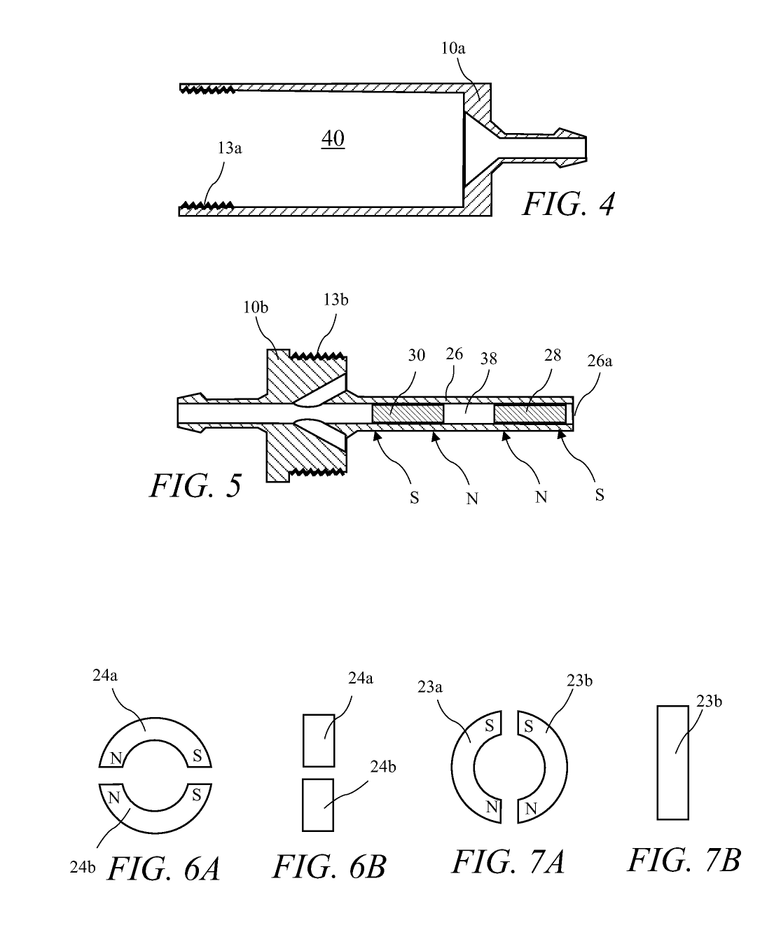

A cross-sectional view taken along line 2-2 of FIG. 1A of the outer body portion 10a of the body of the magnetic fuel treatment device 10 is shown in FIG. 4 and a cross-sectional view taken along line 2-2 of FIG. 1A of the inner body portion 10b of the body of the magnetic fuel treatment device 10 is shown in FIG. 5. The outer body portion 10a and the device 10 is preferably attached to the inner body portion 10b by cooperation of mating threads 13a and 13b. The outer body 10a includes a cavity 40 wherein the holder separator 32 and C-shaped magnets reside.

A front view of the fifth pair of the C-shaped magnets 24a and 24b in a first orientation according to the present invention are shown in FIG. 6A, a side view of the fifth pair of magnets 24a and 24b in the first orientation is shown in FIG. 6B, a front view of the fourth pair of C-shaped magnets 23a in a second orientation of according to the present invention is shown in FIG. 7A, and a side view of the fourth pair of magnets 23a and 23b in the second orientation according to the present invention is shown in FIG. 7B. The magnets are seen to be oriented with like poles facing, and turned 90 degrees with respect to an adjacent pair of C-shaped magnets.

In a method of assembly of the device 10, the magnets 28 and 30 are inserted through the free end 26a of the tube 26, with the cover 27 removed, into the channel 38, being fixed in a preliminarily established location. The cover 27 is thereafter installed, thereby providing a subsequent uniform flow of fuel from the inlet pipe 12 into the annular channel 25. The pairs of the C-shaped magnets are inserted into slots in the holder-separator 32 and the holder-separator 32 and C-shaped magnets are inserted into the cavity 40 of outer body portion 10a. The outer body portion 10a is then attached to the inner body portion 10b.

The device 10 for magnetic treatment and purification of fuel works as follows. The fuel flow goes into the device through the inlet pipe 12, as indicated by the arrow 14 in FIG. 2, flows around the cover 27 of the cylindrical rod 26 and enters the annular channel 25. Under the influence of the magnetic field created jointly by the C-shaped magnets 20a, 20b, 21a, 21b, 22a, 22b, 23a, 23b, 24a, and 24b, and the magnets 28 and 30, the process of fuel purification and treatment occurs in the annular channel 25, during which contamination comprising metal particles is attracted as sediment on the surface of the magnets, and fuel is polarized and structured, which reduces its viscosity, and therefore, increases the rate of flow and efficiency and completeness of combustion.

The fuel flows from the annular channel 25 through the outlet channel 29 as a uniform laminar flow and to the outlet 16, and further, into engine. By careful selection of dimensions (length, diameter, walls thickness) of the body portions 10a and 19b, cover 27, the diameters of the inlet and outlet, the inside passage 38 of the tube 26, and the size of the magnets and their relative position, the effectiveness and the duration of the treatment, may be selected for the best value depending on the type of fuel.

An example of the device is as follows. The body portions 10a and 10b are made of duraluminium. Basic parts of the product had the following dimensions:

the total length of the product—131 mm;

the length of the body (without the inlet fitting)—88 mm;

the length of the cover (without discharge nozzle)—20 mm;

the length of the cylindrical rod—60 mm;

diameter of the body—33 mm;

diameters of the through channel and the rod tubes—5 mm;

the width of C-shaped magnet—10 mm; and

the length of the cylindrical permanent magnet—20 mm.

Tests were performed of an example having five pairs of C-shaped magnets and two cylindrical magnets. The device of magnetic treatment and purification of fuel was installed into the fuel line of the diesel engine of Mercedes 190 car, plate number CLL 335, year of manufacture 1993. Diesel fuel was used. Studies were conducted in the Center of Environmental Researches, Ministry of Ecology and Natural Resources of the Republic of Moldova, to assess the opacity of car engine exhaust gas. The measurements showed that prior to installation of the investigated device the suppression rate of the opacity was 45% (with a maximum permissible rate of 40%), and after installation—no more than 10%.

The example device described above has been installed on vehicles with gasoline carburetor engines in the measurement of carbon monoxide (CO) in exhaust gases. They used as fuel the Al 95 gasoline. In particular, was conducted for cars: Volkswagen Passat, plate number C KE 136, year of manufacture 1996; Volvo 740, plate number C IU 217, year of manufacture 1997; Citroen Xara, plate number C MC 237, year of manufacture 2000. Measurements conducted in both examples showed that use of the patented device reduces the toxicity of the emissions of vehicles of different types. Results are summarized in

TABLE 1

| | | | | | Allowable |
|---|---|---|---|---|---|
| | | Before | After | | reduction |
| | Vehicle | device, | device, | After 1000 km, | of exhaust |
| No. | Make | CO. % | CO. % | CO. % | CO. % |
| 1 | Volkswagon | 0.43 | 0.36 | 0.02 | 1 |
| | Passat Lic No. | | | | |
| | C KE 136 | | | | |
| 2 | Volvo 740 | 0.65 | 0.01 | 0.02 | 1 |
| | lic No. | | | | |
| | C IU 217 | | | | |
| 3 | Citroen Xara | 0.74 | 0.6 | 0.6 | 1 |
| | lic No. | | | | |
| | C MC 237 | | | | |

The results achieved by the useful device 10 according to the present invention, is to efficiently treat fuel, ensuring engine fuel efficiency, as well as reducing pollution in engine exhaust gas. The design of the device 10 provides easy installation and maintenance.

The useful model relates to the field of mechanical engineering and namely to the means of preparation of fuel for combustion in engine, and can be used for fine purification and magnetic treatment of all types of fuel for carburetor and diesel engines, in particular, gasoline, diesel fuel, gas, alcohol-containing liquids, etc.

While the invention herein disclosed has been described by means of specific embodiments and applications thereof, numerous modifications and variations could be made thereto by those skilled in the art without departing from the scope of the invention set forth in the claims.

I claim:

1. A device of magnetic treatment and purification of fuel comprising:
a cylindrical body with an inlet pipe and an outlet pipe;
a magnetic system comprising C-shaped permanent magnets, installed in pairs along the body axis of the device with turning of each next pair at 90° and oriented in pair by same poles facing each other;
a cylindrical tube connected to the body and located inside the magnetic system coaxial with the formation of an annular channel between the outer surface of the tube and the inner surfaces of the C-shaped permanent magnets, the cylindrical tube made with an inner channel in which additional spaced apart permanent magnets reside with same poles facing each other, the free end of the tube is located proximal to the inlet pipe.

2. The device of claim 1, wherein at least two inclined passages are formed between the inlet pipe and the annular passage.

3. The device of claim 2, wherein the inclination angle of the at least two inclined passages is in the range of 35 to 55 degrees to the longitudinal axis of the device.

4. The device of claim 3, wherein a cover resides over an end of the cylindrical tube proximal to the inlet pipe, and the cover is the cone shaped.

5. The device of claim 2, wherein a cover resides over an end of the cylindrical tube proximal to the inlet pipe, and the cover is the cone shaped.

6. The magnetic fuel treatment system of claim 1, wherein the C-shaped permanent magnets comprises at least two pairs of opposing C-shaped magnets rotated approximately 90 degrees with respect to each other.

7. The magnetic fuel treatment system of claim 1, wherein the C-shaped permanent magnets comprises five pairs of opposing C-shaped magnets rotated approximately 90 degrees with respect to each other.

8. A magnetic fuel treatment system comprising:
a housing having an inlet pipe for fuel entry and an outlet pipe for fuel exit;
at least three pair of opposing C-shaped magnets having like poles facing and rotated approximately 90 degrees with respect to a preceding pair of the opposing C-shaped magnets;
two cylindrical magnet residing inside the at least one pair of opposing C-shaped magnets and forming an annulaar passage between the at least one cylindrical magnet and the at least one pair of opposing C-shaped magnets.

9. A magnetic fuel treatment system comprising:
a housing having an inlet pipe for fuel entry and an outlet pipe for fuel exit;
five pairs of opposing C-shaped magnets residing inside the housing and having like poles facing and rotated approximately 90 degrees with respect to a preceding pair of the opposing C-shaped magnets;
two cylindrical magnet residing inside the five pairs of opposing C-shaped magnets and forming an annular passage between the two cylindrical magnet and the five pairs of opposing C-shaped magnets.
